(19) United States
(12) Patent Application Publication
(10) Pub. No.: US 2015/0293891 A1
(43) Pub. Date: Oct. 15, 2015

(54) SYSTEM AND METHOD FOR INTELLIGENTLY MARKING ONLINE AND OFFLINE RESOURCES

(71) Applicant: Aditya WATAL, Uttar Pradesh (IN)

(72) Inventor: Aditya Watal, Allahabad (IN)

(21) Appl. No.: 14/438,218

(22) PCT Filed: Oct. 18, 2013
(86) PCT No.: PCT/IN2013/000632

§ 371 Date: Apr. 23, 2015

(30) Foreign Application Priority Data
Oct. 23, 2012 (IN) 3278/DEL/2012

(51) Int. Cl. G06F 17/24; G06F 17/30

(52) U.S. Cl. CPC G06F 17/241; G06F 17/30887; G06F 17/30908; G06F 17/30896

(57) ABSTRACT

The present invention discloses a technique for marking electronic resources in an online and offline mode on a wide range of digital content access platforms such as web-browsers, document editing applications, or stand alone/collaborative digital content management platforms. The technique includes configuring a digital content access platform on the user access device to enable a marking tool, accessing an electronic resource having a electronic resource locator (ERL) address or comprising one or more hyperlinked ERL addresses, providing a selectable marking icon for each ERL address via the marking tool, creating a marking for the ERL address upon selection of the corresponding selectable marking icon, and storing the created marking within the online platform or within a pre-determined file.

### CROSS REFERENCE TO RELATED APPLICATIONS

This application is related to India Patent Application No. 1771/DEL/2011, entitled “System and Method for Contextual and Collaborative Knowledge Generation and Management through. an Integrated Online-Offline Workspace” and filed on Jun. 22, 2011, which is herein incorporated by reference in its entirety as though fully and completely set forth herein.

### BACKGROUND

The invention relates generally to a technique for marking electronic resources, and in particular to an intelligent tool for marking electronic resources in an online and offline mode.

While browsing for certain content on the network, frequently by means of search tools like Google and Yahoo, end-users retrieve numerous results, not all of which are of use to the user. The user may be interested in fewer results and would like to or prefer to save those key results for future reference such that that he/she has those chosen results handy. Fortunately, content browsing technologies often include a simple indexing technology for memorizing the network addresses of content distributing locations of interest to end-users. Referred to in the art as “bookmarking”, this simple indexing technology, on command, can store the network address (URL address) associated with content actively viewed through the content browser. Subsequently, the end-user can access a list of indexed and stored bookmarks to retrieve previously viewed content from a network address (URL address) associated with the stored bookmark.

However, the current bookmark applications at best bookmark a webpage and allow the user to type in some comment for his/her reference. The process of manually entering reference comment is cumbersome, particularly if the user is looking at multiple pages at a time and wants to bookmark pages of interest to come back to it later for detailed review. Similarly, if a user searches for a topic on a search engine and wants to bookmark few results for future review based on the displayed summary, he needs to open the page and then bookmark it. Bookmarking the search engine page will either open the search engine home page or at best open the search result page. Thus, a user cannot directly bookmark a webpage, by simply bookmarking the associated uniform resource locator (URL) address, without opening the page.

Further, a user may come across web-links while working in an offline mode on his access device. These web-links can be present as hyperlinks in any document saved locally on the user's access device and can probably be of user's interest. Thus the user might want to bookmark one or more of these links. Using the current state of the art bookmarking applications such web-links can only be bookmarked upon opening them through a network connection. Moreover, a user may need to bookmark a file or a document saved locally on the user's access device for future reference. Current bookmarking techniques are limited in their application with respect to offline bookmarking of such electronic resources.

It is therefore desirable to provide an intelligent tool for marking electronic resources that overcomes above discussed and other limitations of current bookmarking applications.

### BRIEF DESCRIPTION

It is an object of the present invention to provide a system and method for intelligently marking electronic resources in an online and offline mode.

It is another object of the present invention to allow a user to bookmark a desired URL address without necessarily opening the corresponding webpage and along with a summary of the webpage.

It is yet another object of the present invention to allow a user to bookmark a webpage along with a desired selected content from within the webpage as a summary for that bookmark.

It is yet another object of the present invention to provide an intelligent marking application compatible with various online and offline digital content access platforms so as to bookmark web-links directly from the platform itself. In one embodiment, it is an object of the invention to bookmark web-links present in files, documents, emails, and applications accessed locally form a user's access device.

It is yet another object of the present invention to provide an intelligent marking application to bookmark offline electronic resources such as a document or a file for future reference along with a summary of the electronic resources.

The present intelligent marking application achieves all the objectives, set forth above. The marking application or tool can be installed on various online and offline digital content access platforms and upon installation, can be used for marking electronic resources in a manner as described later in this patent application. The various online digital content access platforms may include, but are not limited to, web-browsers such as Mozilla Firefox, or Internet Explorer, or Google Chrome, or Safari, or Opera, or the like. The various offline digital content access platforms may include, but are not limited to, applications such as Microsoft Word, Microsoft Outlook, Lotus Notes, Microsoft PowerPoint, Google Desktop search, or the like. The various digital content access platforms may also include, but are not limited to, collaboration-data-management platforms such as Google Does, or Zoho, or MS SharePoint, or the integrated online offline platform described in the related India Patent Application No. 1771/DEL/2011, or the like. The present intelligent marking technique allows a user to mark the whole search result page or each individual search result from the search engine result page along with a summary of content. Additionally, the user may select a portion of the content from the web page which interests him and then hit the selectable marking icon. The intelligent marking technique of the present application not only marks the page but also provides the user selected content or text as the summary. Thus, a user may save the whole search along with the summary of what was searched for, may save each individual result within the search along with a summary that is provided by the search engine, and/or may save individual page along with a user selected content as the summary. Another important aspect of the present marking application is the ability of the application to be locally downloaded and installed on the user's access device, thereby enabling the user to mark any file or document that is accessed locally on the user access device or any hyperlinked URL address present within such files documents.

Other objects, features and advantages of the present invention will be apparent from reviewing the detailed description and drawings of the present invention set forth herein.

### DRAWINGS

Preferred embodiments of the invention will now be described with reference to the attached drawings in which:

FIG. 1 depicts a block diagram of an intelligent marking system in accordance with an embodiment of the present invention;

FIGS. 2-6 illustrate various aspects of an intelligent marking application for marking electronic resources in online mode;

FIG. 7 illustrates an aspect of the intelligent marking application for marking electronic resources in offline mode; and

FIG. 8 is a flowchart illustrating an exemplary process for marking electronic resources in accordance with aspects of the present technique.

### DETAILED DESCRIPTION

According to one embodiment of the present invention, system and method are provided for facilitating marking of electronic resources, in a manner as described subsequently in this detailed description. The invention provides an intelligent marking application or tool that may be employed in various online and offline digital content access platforms. The various online platforms may include, but are not limited to, web-browsers such as Mozilla Firefox, or Internet Explorer, or Google Chrome, or Safari, or Opera, or the like. The various offline platforms may include, but are not limited to, applications such as Microsoft Word, Microsoft Outlook, Lotus Notes, Microsoft PowerPoint, Google Desktop search, or the like. The various digital content access platforms may also include, but are not limited to, collaboration-data-management platforms such as Google Docs, or Zoho, or MS SharePoint, or the integrated online-offline platform described in the related India Patent Application No. 1771/DEL/2011, or the like. Further, the intelligent marking application may also be employed locally for offline marking of electronic resources such as documents or files saved locally on a user's access device or hyperlinks from within the locally stored documents or files.

The present invention is now described with reference to the drawings, wherein like reference numerals are used to refer to like elements throughout.

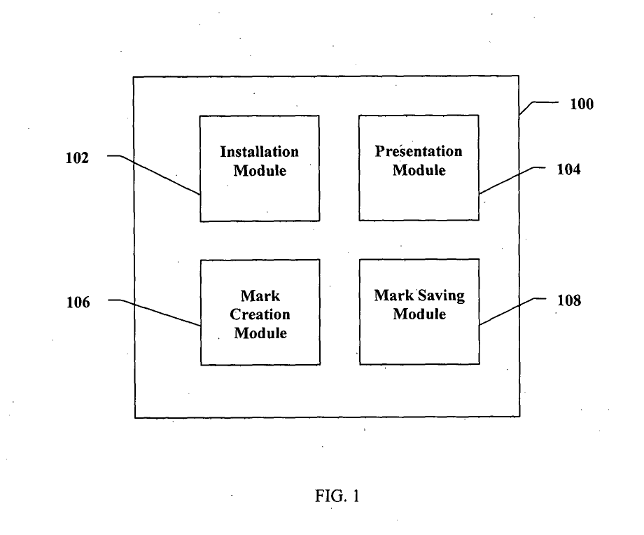

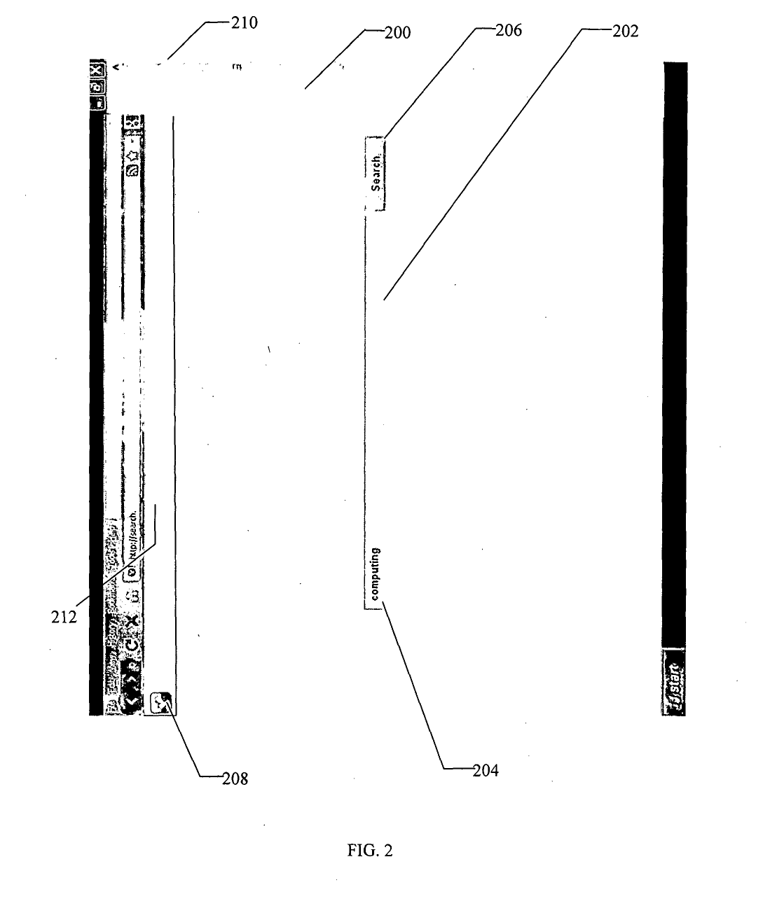

FIG. 1 depicts a block diagram of the intelligent marking system 100 for marking electronic resources according to the present invention. The system 100 may include at least a portion of a processor based user's access device, such as a desktop computer, a laptop computer, a personal digital assistant, a Smartphone, a mobile phone, or the like. It should also be understood that although several modules in FIG. 1 are depicted as residing within system 100, such modules may alternatively reside in a different system. An installation module 102 installs the intelligent marking application or tool within a digital content access application or platform on the user's access device, as requested by the user. A presentation module 104 presents the installed intelligent marking application within the digital content access application or platform to the user through graphical user interfaces (GUIs). The GUIs enable the user to interact with the intelligent marking application as will be described in greater detail with reference to FIGS. 2-7. Additionally, a mark creation module 106 allows the user to create bookmarks for electronic resources in multiple ways via the GUIs. Once a bookmark is created, a mark saving module 108 saves it within a bookmark memory (not shown in the drawings). The bookmark memory may reside on one or more remote servers accessible over a network as in online platform, this memory will subsequently be referred to as the online bookmark memory; or locally within a pre-determined file on the user's access device as in offline application or platform, this memory will subsequently be referred to as the offline bookmark memory; or both. It should be noted that, in certain embodiments, the bookmark memory may be part of the one or more modules of the system 100.

Referring now to FIG. 2, an interface 200 represents an online search engine's interface or webpage within a web-browsing application's window 210. The search engine may be any of the search engines available on the World Wide Web (WWW) such as Google search engine, or Yahoo search engine, or Wikipedia search engine, or MSN search engine, or Dogpile search engine, or the like. Also, the web browsing application may include, but is not limited to, web-browsers such as Mozilla Firefox, or Internet Explorer, or Google Chrome, or Safari, or Opera, or the like. A text or query box 202 is provided by the search engine within the interface 200 where the user enters search query 204 and subsequently clicks on a search button 206 to retrieve the search results for the query 204. Upon installation of intelligent marking application or tool by the application installation module 102, a selectable marking icon 208 is presented by the presentation module 104 on the toolbar 212 associated with the web-browsing application's window 210. It should be noted that the selectable marking icon 208 is displayed on the toolbar 212 irrespective of the interface currently active within the web-browsing application's window 210. However, the user may anytime choose to hide or temporarily disable the selectable marking icon 208 by customizing his web-browser's toolbar settings.

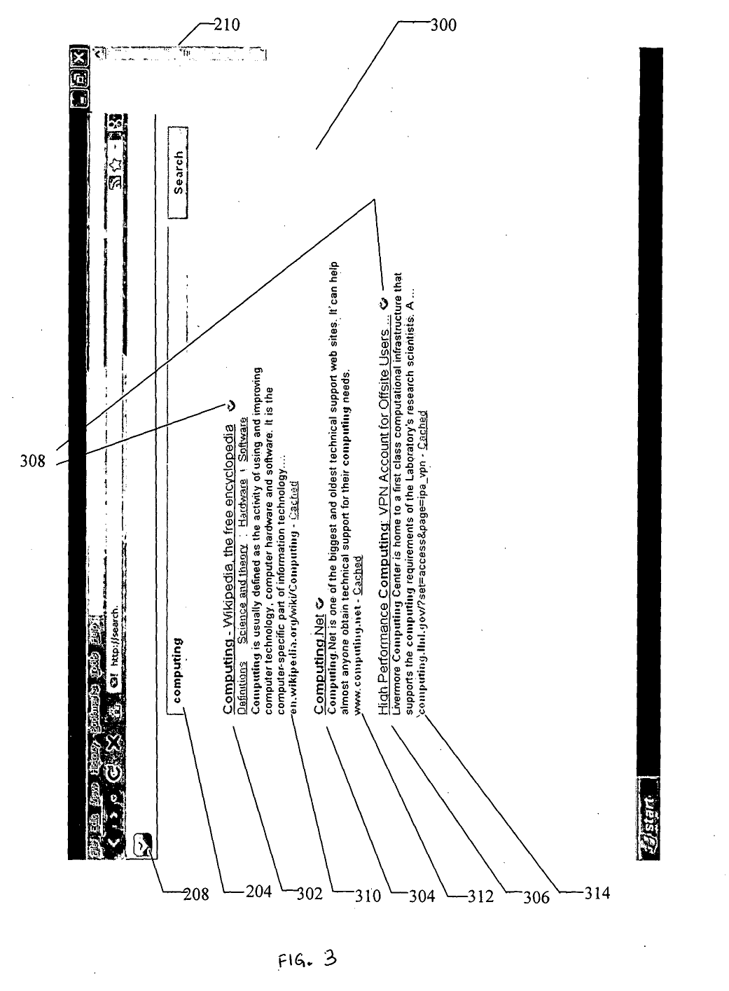

Turning now to FIG. 3, a search result page 300, corresponding to the user's query 204, is displayed within the web-browsing application's window 210. Shown by 302, 304, and 306 are the search results retrieved by the search engine. These search results 302, 304, and 306 are displayed along with their respective uniform resource locator (URL) addresses as indicated by 310, 312, and 314. Upon detection of one or more hyperlinked URL addresses within the search result page 300, or within any other webpage currently active in the web-browsing application's window 210, the presentation module 104 inserts or embeds a selectable marking icons 308 with each of the one or more hyperlinked URL addresses. While only three search results and their corresponding embedded selectable marking icons have been illustrated in the figure, it is to be understood that several of such results may be retrieved by the search engine and with every such result a selectable marking icon 308 will be associated.

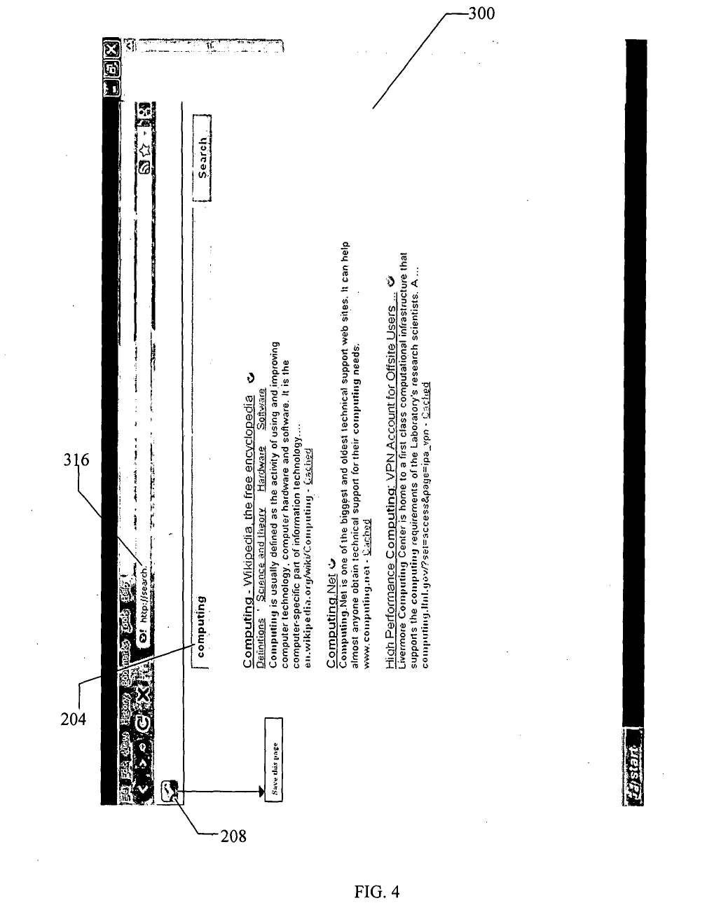

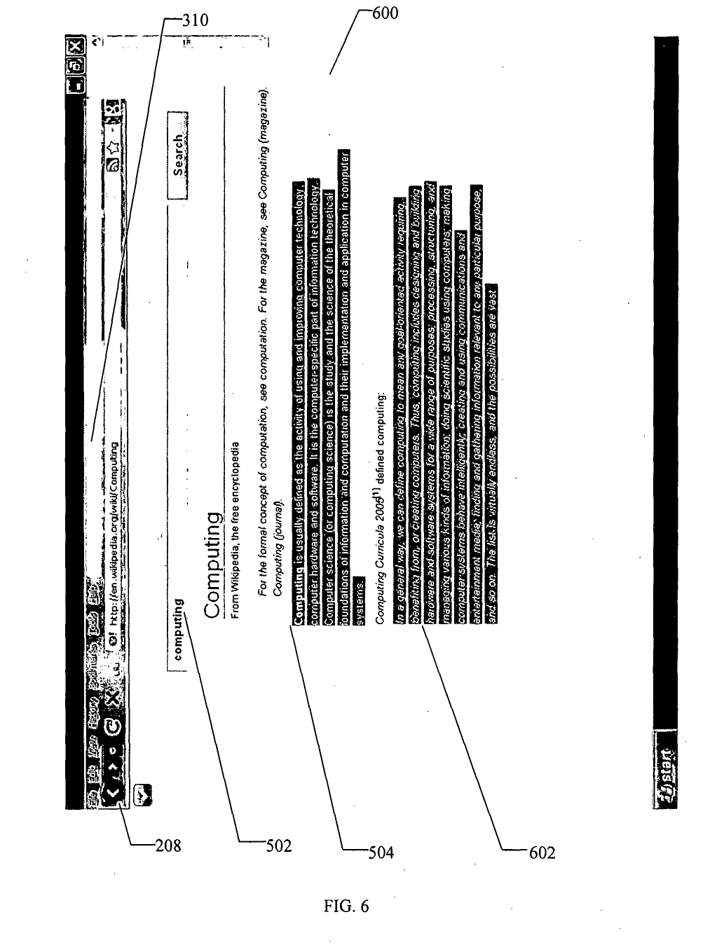

The intelligent marking application allows a user to mark either an entire webpage or interface 200 currently active within the web-browsing application's window 210, or a hyperlinked URL address 310, 312, and 314 present within the webpage or interface 200 upon selection of the selectable marking icon 208 or 308 respectively via the mark creation module 106. As illustrated in FIG. 4, the user can create a bookmark for the entire search result page 300 by clicking on the selectable marking icon 208. It should be noted that the text description “Save this page” associated with marking icon 208 is for illustration purpose only. This or other such descriptive text may be displayed to aid the user on moving the cursor or mouse to the marking icon 208. Once the bookmark is created, the mark saving module 108 allows the user to save the created bookmark in the bookmark memory. The user may choose to save the bookmark in the online and/or offline bookmark memories. It should be noted that saving the bookmark in the offline bookmark memory makes the bookmarked webpage available to the user even in the absence of a network connection. As will be appreciated by those skilled in the art, this feature is enabled by downloading of the entire webpage so as to make it available offline. Further, the bookmark is saved along with a default, user-defined, or user-selected summary of the webpage or the interface 300. In certain embodiments, a created bookmark is saved along with a title, a summary, and the corresponding URL address. For example, as shown in FIG. 4, saving the bookmark created for the search result page 300 saves the bookmark with: a title 204, which is the search query input by the user; a summary, which is a default summary, as provided by the search engine for the search conducted; and a URL address 316 which corresponds to the worldwide web address of the search result page 300. It should be noted that, in certain embodiments, the intelligent marking application may be configured to accept a user-defined summary of the bookmark upon clicking of the selectable marking icon 208. Additionally, as will be described with reference to FIG. 6, the summary for the bookmark can be user-selected, instead of the default summary, if so desired by the user.

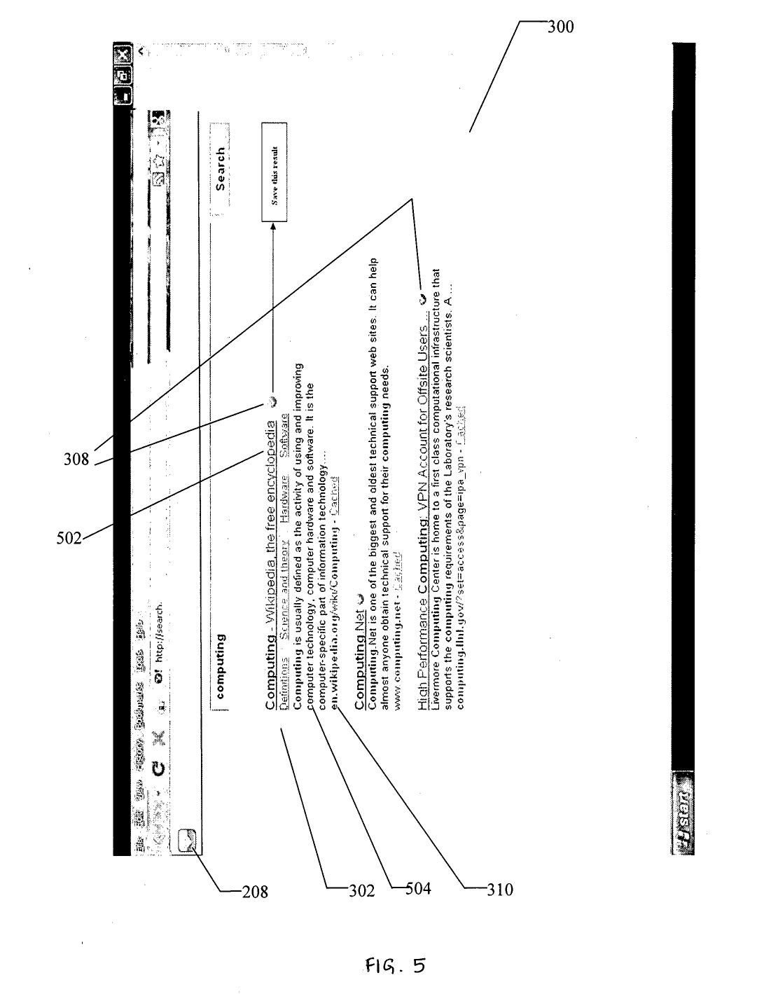

Referring now to FIG. 5, another aspect of the intelligent marking application is described in reference to the search result page 300. The user often gets a fair idea of the relevancy of a particular result by its title and the summary provided. As the number of search results retrieved for a query is generally exhaustive, it is time-consuming to open every result and thereafter bookmark it. Thus, the present intelligent marking application enables the user to directly bookmark one or more search results without having to necessarily open the webpage associated with the desired result. This is accomplished by clicking selectable marking icons 308. If the user finds the result 302 relevant to his search, he can create a bookmark for this result by simply clicking on the selectable marking icons 308 without essentially opening the webpage corresponding to the result 302. Again, it should be noted that the text description “Save this page” associated with marking icon 308 is for illustration purpose only. This or other such descriptive text may be displayed to aid the user on moving the cursor or mouse to the marking icon 308. The saving of bookmark created through the marking icons 308 is similar to the saving of bookmark created through the marking icon 208 as described above with reference to FIG. 4. Also, the user may choose to save the bookmark in any of the online and/or offline bookmark memories. Saving the bookmark created for the search result 302 saves the bookmark with: a title 502, which is the title for the search result as displayed on the search result page 300; a summary 504, which is a default summary corresponding to the search result 302; and a URL address 310 which corresponds to the worldwide web address of the search result 302. Here again, it should be noted that, in certain embodiments, the intelligent marking application may be configured to accept a user-defined summary of the bookmark upon clicking of the selectable marking icon 208. Additionally, as will be described with reference to FIG. 6, the summary for the bookmark can be user-selected, instead of the default summary, if so desired by the user.

FIG. 6 shows an aspect of the intelligent marking application wherein the user may select the summary to be saved along with the bookmark. Shown in the FIG. 6 is the webpage 600 which is opened upon clicking on the search result 302 of search result page 300. Bookmarking either the currently active page 600 or the search result 302 saves the bookmark with the default summary 504. However, the user, if he so desires, can save the bookmark with desired web content as the summary. In case the user wants to bookmark the webpage 600 with the web-content 602 as the summary, the user needs to select the web-content 602 prior to hitting the selectable marking icon 208. Once the web-content 602 is selected, the user may hit the selectable marking icon 208 to create a bookmark. The bookmark thus created will be saved along with: a title 502; a summary comprising the web-content 602; and a URL address 310. This summary comprising web-content 602, instead of the default summary 504, is the user-selected summary. While the webpage 600 is shown to explain this feature, it should be noted that this feature of the intelligent marking application remains the same for any other webpage currently active within web-browsing application's window 210.

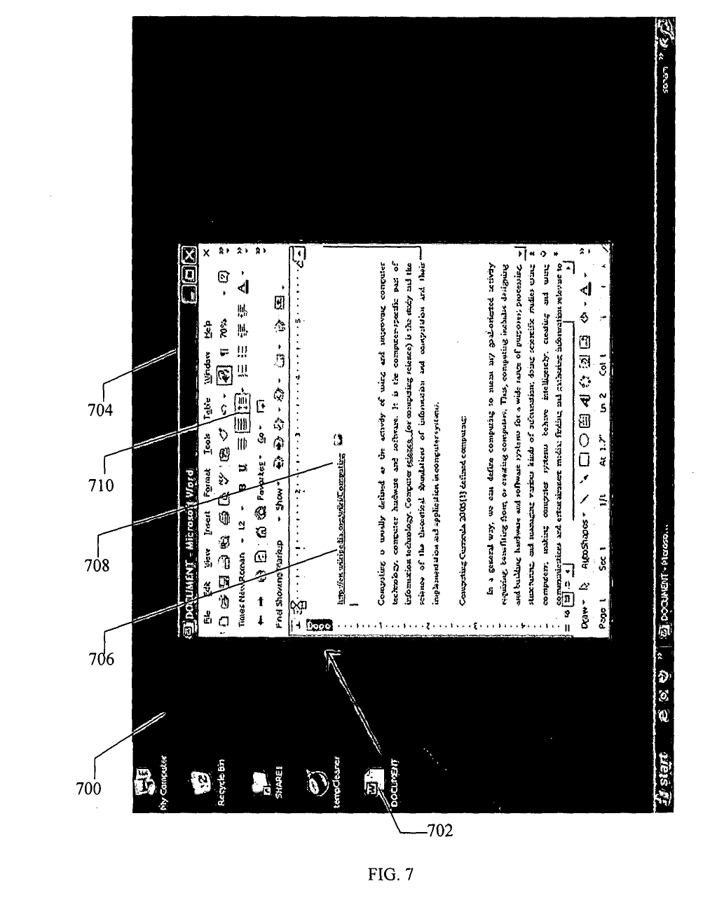

FIG. 7 illustrates an aspect of the intelligent marking application for marking electronic resources in offline mode. Once installed by the application installation module 102 on any offline platform, the intelligent marking application may be used to create bookmarks for hyperlinked URL addresses present within any file or document saved locally on the user's access device and accessed via the offline platform. Shown by 700 is desktop window of user's access device. In an exemplary embodiment, a MS word document 702 is saved on the desktop which upon being accessed by MS Word application (offline digital content access platform) opens as the complete document within the MS Word application window 704. As illustrated, the document 702 contains a hyperlinked URL address 706. The intelligent marking application parses the document 702 and upon detection of the hyperlinked URL address 706, the presentation module 104 embeds and displays a selectable marking icon 708, associated with the hyperlinked URL address 706. Clicking the selectable marking icon 708 creates a bookmark for the hyperlinked URL address 706. The created bookmark may be saved in the online and/or offline bookmark memory. It should be noted that saving the bookmark in the offline bookmark memory makes the bookmarked webpage available to the user even in the absence of a network connection. As will be appreciated by those skilled in the art, this feature is enabled by downloading of the entire webpage on detection of the network connection so as to make it available offline. Further, the bookmark may be saved along with a default, a user-defined, or a user-selected summary. For example, in certain embodiments, the bookmark may be saved along with: a title that may be title of the associated webpage; a summary comprising default summary of webpage or default summary and/or name and location of the document 702 within the user's access device; and the hyperlinked URL address 706. Alternatively, in certain embodiments, the intelligent marking application may be configured to accept a user-defined summary of the bookmark. Alternatively, in certain embodiments, the summary for the bookmark may be user-selected portion of the document 702.

As will be appreciated by those skilled in the art, in certain embodiments, the intelligent marking application may bookmark the file or document saved locally on the user's access device by clicking on the selectable marking icon present on the toolbar of the digital content access platform. For example, with respect to FIG. 7, upon installation of the intelligent marking tool, a selectable marking icon (not shown) may be presented on the toolbar 710 of the MS Word application window 704. The user may create a bookmark for the entire document 702 by clicking on the selectable marking icon. Once the bookmark is created, the created bookmark may be saved in the bookmark memory. In certain embodiments, a created bookmark is saved along with a name of the document, a summary, and a corresponding file location. The user may choose to save the bookmark in the online and/or offline bookmark memories. It should be noted that saving the bookmark in the online bookmark memory makes the bookmarked document 702 available to the user over online platform. As will be appreciated by those skilled in the art, this feature is enabled by uploading of the document 702 on the online bookmark memory so as to enable its access over online platform. Further, the bookmark is saved along with a default, a user-defined, or a user-selected summary of the document 702. The default summary may be a title or abstract of the document 702. Alternatively, user may choose to enter some notes as a user-defined summary while bookmarking the document 702. Finally, as discussed above with reference to FIG. 6, the summary may be a user-selected portion of the document 702.

It should be noted that the intelligent marking application may be installed in a variety of other online and/or offline digital content access platform and applications such as Microsoft Outlook, Lotus Notes, Microsoft PowerPoint, Adobe Acrobat, Google Desktop search, Copernic Desktop search, any mobile or desktop applications, and so forth. In certain embodiments, the interface 200, 300, and 600 such as one described with reference to FIGS. 2-6 may be an offline or a desktop search engine's interface such as that of Google Desktop search, Copernic Desktop search, and so forth within the respective application window. A local search performed via the desktop search engine may display a number of documents, emails, or files as search result. Similar to the techniques described with reference to FIGS. 2-6, the intelligent marking application installed on the desktop search application may enable the user to bookmark the entire search result or one or more of the individual search results directly from the desktop search engine's interface via a selectable marking icon. The user may choose to save the bookmark in any of the online and/or offline bookmark memories. The created bookmark is saved along with a title, a summary, and the corresponding file location. Here again, it should be noted that, the summary may be a default, a user-defined, or a user-selected summary.

As will be appreciated by one skilled in the art, a variety of techniques may be employed to mark electronic resources. For example, the exemplary intelligent marking system 100 may mark electronic resources by the techniques discussed herein. In particular, as will be appreciated by those of ordinary skill in the art, control logic and/or automated routines for performing the techniques and steps described herein may be implemented by the intelligent marking system 100 of FIG. 1, either by hardware, software, or combinations of hardware and software. For example, suitable code may be accessed and executed by the intelligent marking system 100 to perform some or all of the techniques described herein. Similarly application specific integrated circuits (ASICs) configured to perform some or all of the techniques described herein may be included in the intelligent marking system 100.

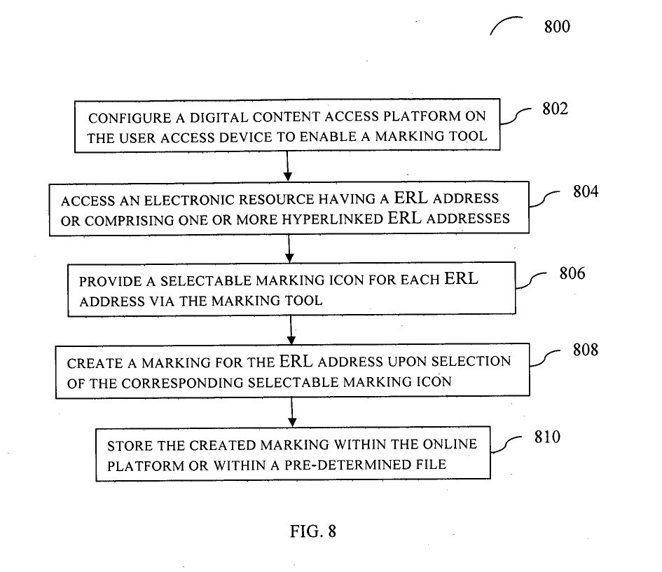

For example, referring now to FIG. 8, exemplary control logic 800 for marking electronic resources via a marking application, such as the intelligent marking tool described above, is depicted via a flowchart in accordance with aspects of the present technique. As illustrated in the flowchart, the control logic 800 includes the steps of configuring a digital content access platform on the user access device to enable a marking tool at step 802, accessing an electronic resource having a electronic resource locator (ERL) address or comprising one or more hyperlinked ERL addresses at step 804, providing a selectable marking icon for each ERL address via the marking tool at step 806, creating a marking for the ERL address upon selection of the corresponding selectable marking icon at step 808, and storing the created marking within the online platform or within a pre-determined file at step 810.

As discussed above, the digital content access platform is an online collaborative digital content management platform, a stand-alone digital content management platform, a web-browser, a document editing application, or any other similar online or offline platform. Further, as will be appreciated by those skilled in the art, the ERL address is a local or network address of an electronic resource. For example, the ERL address may be a uniform resource locator (URL) address of a webpage, or a location or path of an electronic resource within the user access device such as document location, file path, and so forth. Moreover, it should be noted that the selectable marking icon may be any visual indicator such as an image, a text, a marker, or a combination thereof. The selectable marking icon may be integrated within the digital content access platform for marking the electronic resource having the ERL address. Further, in certain embodiments, the selectable marking icon may be embedded within the accessed electronic resource comprising the one or more hyperlinked ERL addresses and placed next to each of the each of ERL addresses.

In certain embodiments, storing the marking at step 810 comprises storing the marking with a title, a summary, and the ERL address corresponding to the marked electronic resource having the ERL address or the marked hyperlinked ERL address from within the electronic resource. It should be noted that the summary may be a default summary based upon parsing of the electronic resource or a user-defined summary based on notes entered by the user. Alternatively, in certain embodiments, the summary may be a user-selected summary based upon selection made by the user within the electronic resource. The stored marking may reside within a pre-determined file on the user access device. Further, in certain embodiments, the stored marking may reside within the digital content access platform.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

1. A method for marking, the method comprising:
configuring a digital content access platform on the user access device to enable a marking tool;
accessing an electronic resource having a electronic resource locator (ERL) address or comprising one or more hyperlinked ERL addresses;
providing a selectable marking icon for each ERL address via the marking tool;
creating a marking for the ERL address upon selection of the corresponding selectable marking icon; and
storing the created marking within the online platform or within a pre-determined file.

2. The method of claim 1, wherein the digital content access platform is an online collaborative digital content management platform, a stand-alone digital content management platform, a web-browser, a document editing application, or any other similar online or offline platform.

3. The method of claim 1, wherein the selectable marking icon is integrated within the digital content access platform for marking the electronic resource having the ERL address.

4. The method of claim 1, wherein the selectable marking icon is embedded within the accessed electronic resource comprising the one or more hyperlinked ERL addresses and placed next to each of the one or more hyperlinked ERL addresses.

5. The method of claim 1, wherein storing the marking comprises storing the marking with a title, a summary, and the ERL address corresponding to the marked electronic resource having the ERL address or the marked hyperlinked ERL address from within the electronic resource.

6. The method of claim 5, wherein the summary is a default summary based upon parsing of the electronic resource or a user-defined summary based on notes entered by the user.

7. The method of claim 5, wherein the summary is a user-selected summary based upon selection made by the user within the electronic resource.

8. The method of claim 1, wherein the stored marking resides within a pre-determined file on the user access device or within the digital content access platform.

9. The method of claim 1, wherein the ERL address comprises a uniform resource locator (URL) address, or a location or path of an electronic resource within the user access device.

10. A system for marking, the system comprising:
an installation module for enabling a marking tool within a digital content access platform on a user access device;
a presentation module for providing a selectable marking icon for each ERL address via the marking tool; and
a mark creation module for creating a marking for the ERL address upon selection of the corresponding selectable marking icon; and
a mark storing module for storing the created marking within the digital content access platform or within a pre-determined file.
